(19) United States
(12) Patent Application Publication
(10) Pub. No.: US 2025/0047798 A1
(43) Pub. Date: Feb. 6, 2025

(54) IMAGE READING APPARATUS

(71) Applicant: CANON KABUSHIKI KAISHA, Tokyo (JP)

(72) Inventor: KAZUKI MATSUO, Kanagawa (JP)

(21) Appl. No.: 18/786,284

(22) Filed: Jul. 26, 2024

(30) Foreign Application Priority Data
Aug. 2, 2023 (JP) 2023-126451

(51) Int. Cl. H04N 1/12

(52) U.S. Cl. CPC H04N 1/123; H04N 1/1245

(57) ABSTRACT

An image reading apparatus, including: a document transport portion including a transport mechanism; a first guide which is provided in the document transport portion and guides a document transported in a transport direction; a second guide arranged on a downstream side; and an image reading portion which includes a reading unit provided with the second guide and reads, at a reading position, an image of a document having passed through a transport path formed by the first guide and the second guide, wherein the transport path includes a first and a second transport region that differ from each other in an intersecting direction, and a document is guided from the first guide to the reading position in the first transport region and guided in an order of the first guide, the second guide, and the reading position in the second transport region.

### BACKGROUND OF THE INVENTION

### Field of the Invention

The present invention relates to an image reading apparatus.

### Description of the Related Art

Conventionally, reading apparatuses which are mounted to an ink-jet printer, an all-in-one printer, a copier, a facsimile machine, or the like and which read an image recorded on a document are known. In addition, a transport apparatus including sheet transport means which transports a sheet to a reading portion and a sheet transport path which guides the sheet is used in such reading apparatuses. When transporting a sheet with such a transport apparatus, the sheet must be transported so that lift of the sheet does not occur in the reading portion in order to prevent reading accuracy of the image from declining. For example, Japanese Patent Application Laid-open No. 2013-251692 discloses a sheet transport apparatus which includes a transport guide with an arc-shaped cross section on an upstream side in a transport direction of a reading portion and which transports a sheet to the reading portion via the arc-shaped transport guide.

### SUMMARY OF THE INVENTION

The configuration according to Japanese Patent Application Laid-open No. 2013-251692 is problematic in that when a distal end of the arc-shaped transport guide deforms due to warping or the like, lift of a sheet of paper occurs in the reading portion and causes an image defect.

The present invention has been made in consideration of the problem described above and an object thereof is to provide an image reading apparatus capable of suppressing lift of a sheet of paper.

The present invention provides an image reading apparatus, comprising:
a document transport portion including a transport mechanism configured to transport a document;
a first transport guide which is provided in the document transport portion and which is configured to guide a document transported in a transport direction by the transport mechanism;
a second transport guide which is at least partially arranged on a downstream side of the first transport guide in the transport direction and which is configured to guide a document transported in the transport direction; and
an image reading portion which includes a reading unit provided with the second transport guide and configured to read, at a reading position, an image of a document having passed through a transport path formed by the first transport guide and the second transport guide,
wherein
the transport path includes a first transport region and a second transport region that differs from the first transport region in an intersecting direction that intersects with the transport direction, and
a document is guided from the first transport guide to the reading position in the first transport region and guided in an order of the first transport guide, the second transport guide, and the reading position in the second transport region.

The present invention can provide an image reading apparatus capable of suppressing lift of a sheet of paper.

Further features of the present invention will become apparent from the following description of exemplary embodiments with reference to the attached drawings.

### BRIEF DESCRIPTION OF THE DRAWINGS

FIG. 1 is a perspective view of an open state of an image reading apparatus;

FIG. 2 is a perspective view of a closed state of the image reading apparatus;

FIG. 3 is a sectional view of the image reading apparatus when an automatic sheet feeding apparatus is closed;

FIG. 4 is a partially enlarged sectional view of the image reading apparatus when the automatic sheet feeding apparatus is closed;

FIG. 5A is a top view and FIGS. 5B to 5D are sectional views of a scanner portion;

FIG. 6 is a rear view of a glass frame unit;

FIG. 7 is a top view showing an internal configuration of the image reading apparatus;

FIG. 8 is an exploded perspective view of a transport path;

FIG. 9 is an exploded plan view of transport guides;

FIG. 10 is an exploded perspective view of a transport guide;

FIG. 11 is a perspective view of transport guides;

FIG. 12 is a plan view of the transport guides;

FIG. 13 is an exploded view of a glass frame unit according to a first embodiment;

FIG. 14 is a perspective view of transport guides according to a second embodiment;

FIG. 15 is a perspective view showing a reading unit; and

FIG. 16 is a block diagram showing a configuration example of a control circuit of an apparatus.

### DESCRIPTION OF THE EMBODIMENTS

Hereinafter, configurations according to the present invention will be described in greater detail with reference to the drawings. However, it is to be understood that dimensions, materials, shapes, relative arrangements, and the like of components described in the embodiments are not intended to limit the scope of the present invention to such embodiments unless specified to the contrary. In addition, materials, shapes, and the like of members once described in the following description are the same in latter descriptions as those in a first description unless specified to the contrary. Widely known techniques or publicly known techniques in the technical field can be applied to configurations and processes that are not particularly illustrated or described. Furthermore, redundant descriptions may be omitted.

An image reading apparatus mounted with a sheet transport mechanism according to the present invention can be applied to a flatbed scanner apparatus, a copier combining a flatbed scanner apparatus and a printer apparatus, a facsimile, an all-in-one printer, and the like. Hereinafter, an image reading apparatus which imports a sheet image to a computer or the like will be described as an example. Note that same reference numerals denote same or corresponding parts throughout the drawings. X, Y, and Z denote directions that are orthogonal to each other. X denotes a width direction of an image reading apparatus, Y denotes a depth direction thereof, and Z denotes a height direction thereof.

### First Embodiment

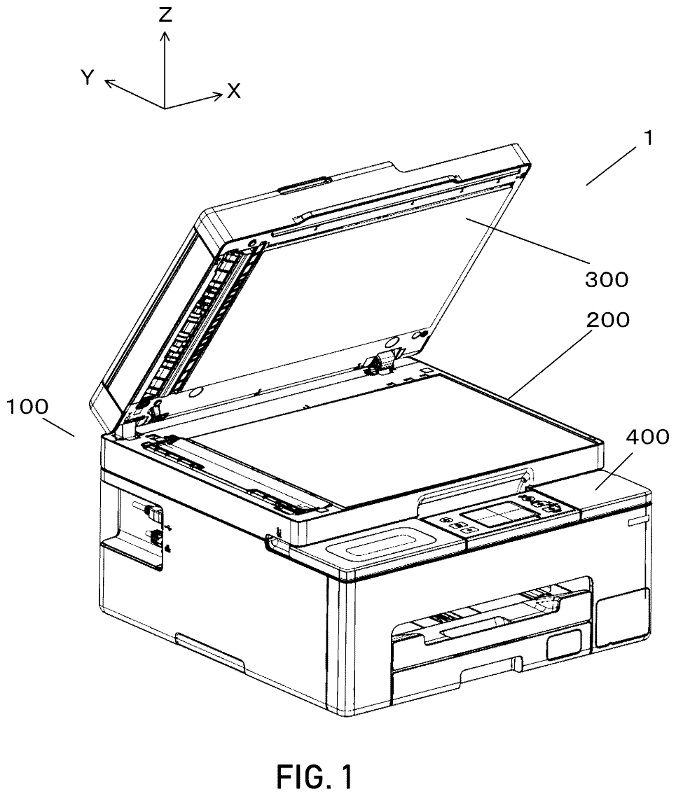

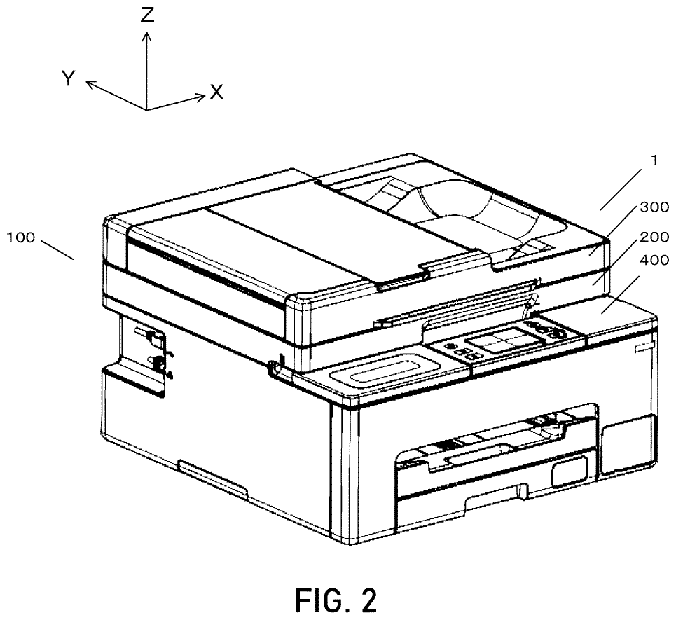

FIGS. 1 and 2 are external perspective views of an all-in-one printer 1 which combines an image reading apparatus main body 100 according to the present invention with a printer apparatus 400 that is an ink-jet printer. The image reading apparatus main body 100 according to the present embodiment is roughly constituted of an image reading portion (hereinafter, a scanner portion 200) and a sheet transport portion (a document transport portion hereinafter referred to as an ADF portion 300). In this case, an ADF (Auto Document Feeder) refers to an automatic document transport apparatus which is a mechanism for sequentially and automatically transporting a plurality of documents to the reading portion. The ADF portion 300 is openable and closeable with respect to the scanner portion 200. FIG. 1 shows a state where the ADF portion 300 has been opened to allow a sheet to be placed on the scanner portion 200. FIG. 2 shows a state where the ADF portion 300 is closed.

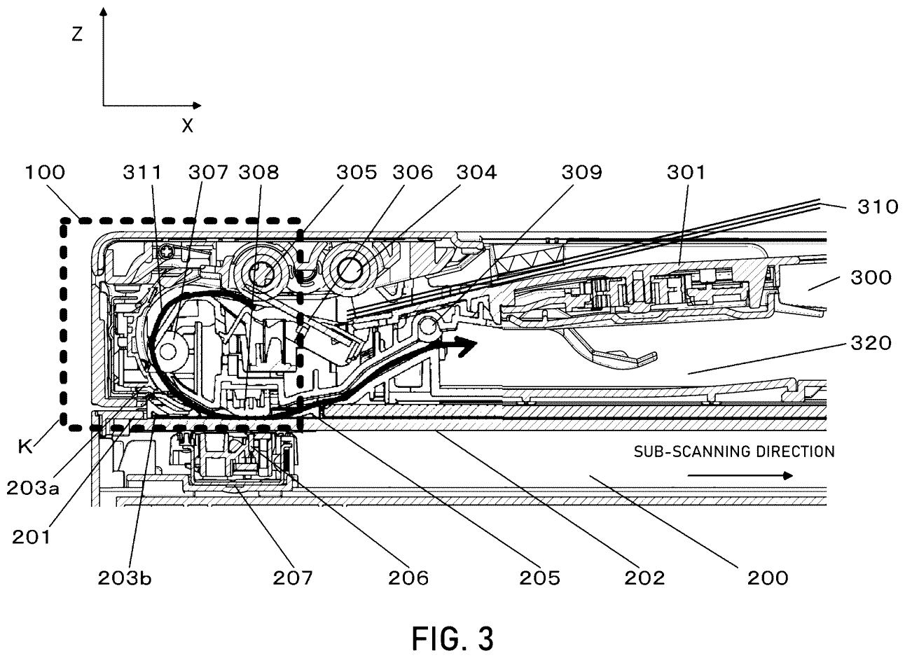

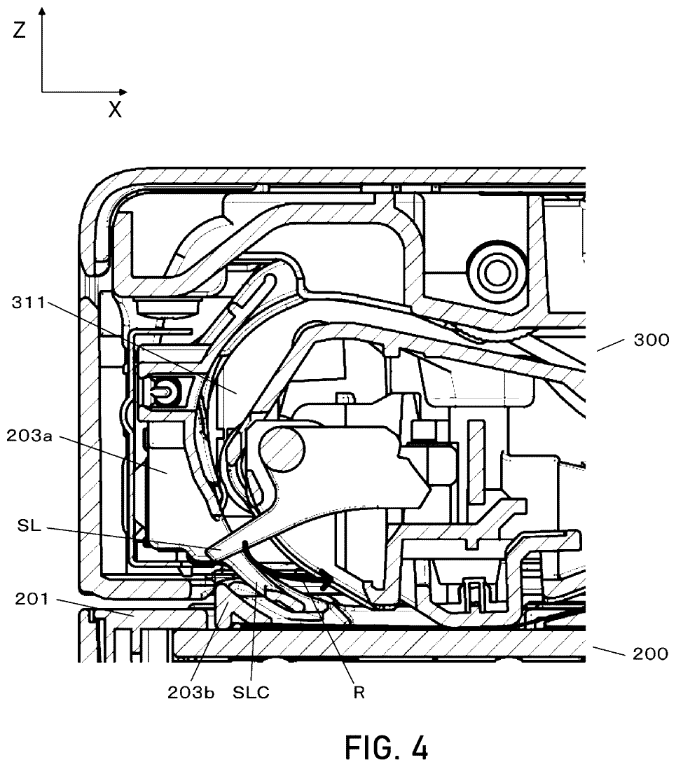

Hereinafter, a configuration of the ADF portion 300 of the image reading apparatus main body 100 will be described with reference to FIGS. 3 and 4. FIG. 3 is a cross section along an X-Z plane of the scanner portion 200 and the ADF portion 300 which constitute the image reading apparatus main body 100 when the ADF portion 300 is closed. FIG. 3 shows a configuration of a sheet transport path 311 (thick solid arrow) in the ADF portion 300 in which a part of the sheet transport path 311 is constituted of a part of the scanner portion 200.

The ADF portion 300 includes a sheet mounting table 301 on which sheets are to be mounted, a sheet transport mechanism portion (transport mechanism), and a discharged sheet stacking portion 320. A configuration of the sheet transport mechanism portion will now be described in sequence starting from an upstream side of sheet transport. In this case, the sheet transport mechanism portion refers to an entire sheet transport mechanism from a pickup roller 304 to a discharge roller 309 to be described below.

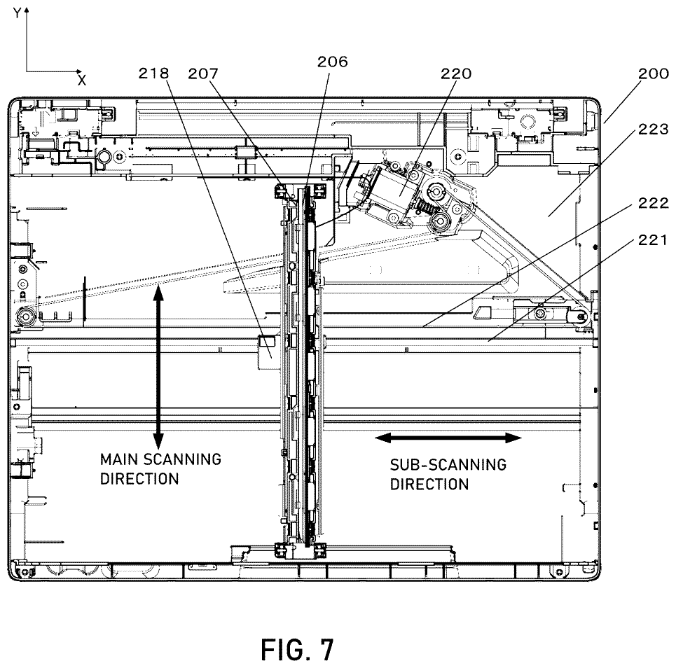

Transported sheets 310 to be automatically transported which are mounted to the sheet mounting table 301 are transported toward a separation roller 305 by the pickup roller 304 of the sheet transport mechanism portion. Subsequently, the transported sheets 310 are transported, one sheet at a time, to a downstream-side transport roller 307 by the separation roller 305 and a separation pad 306. Next, each transported sheet 310 is passed through a first transport guide 203a by the transport roller 307 and transported to a downstream-side second transport guide 203b. When passing through the second transport guide 203b, the transported sheet 310 is pressed by a white pressing plate 308 and adheres to the second transport guide 203b. At this point, the transported sheet 310 is read by an image sensor 206. The white pressing plate 308 is large enough to cover an entirety of the image sensor 206 shown in FIG. 7 in a main scanning direction.

Next, the transported sheet 310 having passed through the second transport guide 203b passes through a sheet size index member 205 on a downstream side of the second transport guide 203b in a transport direction and is discharged to the discharged sheet stacking portion 320 by the downstream-side discharge roller 309. The second transport guide 203b and the sheet size index member 205 described above are constituent members of the scanner portion 200. Various sheet detection sensors (not illustrated) are arranged in the sheet transport mechanism portion to detect passage of a leading end and a trailing end of a sheet, and outputs of the sheet detection sensors are used for timing control of a read by the image sensor 206.

Reading systems of a sheet to be adopted by the image reading apparatus main body 100 according to the present invention can be selected from two systems: a sheet fixed reading system (flatbed reading) and a sheet transported reading system (ADF reading). The sheet fixed reading system is a system that reads a sheet by fixing the sheet on a sheet set table glass 202 which is a mounting table and moving a reading unit 207 in a sub-scanning direction (X direction). In addition, the sheet transported reading system is a system that reads a sheet by stopping the reading unit 207 at a prescribed position (ADF position) below the second transport guide 203b and transporting the sheet with the ADF portion 300. Note that while the sheet set table glass 202 doubles as an ADF glass at the ADF position in the present invention, the sheet set table glass 202 and the ADF glass may be separated. In a sheet fixed reading mode, the sheet set table glass 202 functions as a mounting table in which a document is mounted to one surface and the reading unit 207 arranged on a side of another surface reads the document. In an ADF reading mode, the sheet set table glass 202 functions as a flat plate member which allows a document to be read by causing the document to smoothly pass a reading position while maintaining a prescribed distance between the document which passes along the one surface and the reading unit 207 which is arranged on the other surface.

The reading unit 207 in the scanner portion 200 in FIG. 3 represents a state where the reading unit 207 is standing-by at the ADF position in order to read the transported sheet 310 to be automatically transported by the ADF portion 300 described earlier.

FIG. 4 is an enlarged view of a dotted line portion K in FIG. 3. The dotted line portion K represents a configuration in which the first transport guide 203a is attached to the ADF portion 300 and the second transport guide 203b is attached to a glass frame unit 201 of the scanner portion 200. The sheet transport path 311 is provided with a sensor lever SL for detecting a sheet which comes into contact with the sheet being transported and rotates in an arrow direction R. The first transport guide 203a includes a notched portion SLC into which the rotating sensor lever SL is retracted.

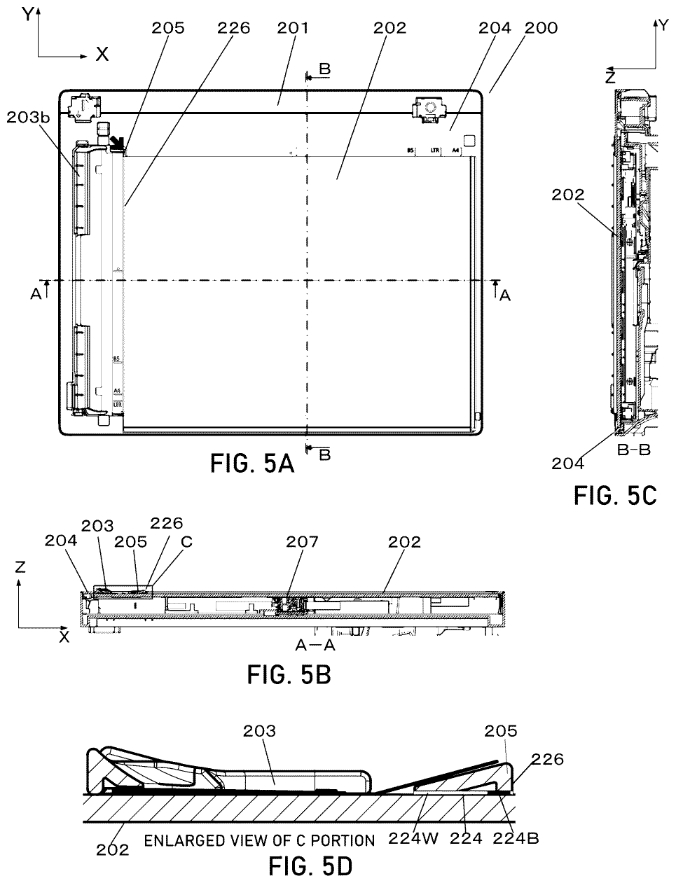

Hereinafter, a configuration of the scanner portion 200 of the image reading apparatus main body 100 according to the present embodiment will be described with reference to FIGS. 5A to 7.

FIG. 5A is a top view of the scanner portion 200 when the ADF portion is removed from the image reading apparatus main body and which shows an entirety of the glass frame unit 201. The glass frame unit 201 is constituted of the sheet set table glass 202 for mounting sheets and a glass frame 204 which holds the second transport guide 203b described earlier for reading an automatically transported sheet. In addition, the glass frame 204 is equipped with the sheet size index member 205 described earlier and a sheet abutting reference 226 between the sheet set table glass 202 and the second transport guide 203b.

FIG. 5B is a cross section along A-A in FIG. 5A. FIG. 5C is a cross section along B-B in FIG. 5A which shows a cross section of the reading unit 207 in a main scanning direction (Y direction). FIG. 5D is an enlarged view of a C portion around the sheet size index member 205 of the glass frame unit 201 shown in FIG. 5B.

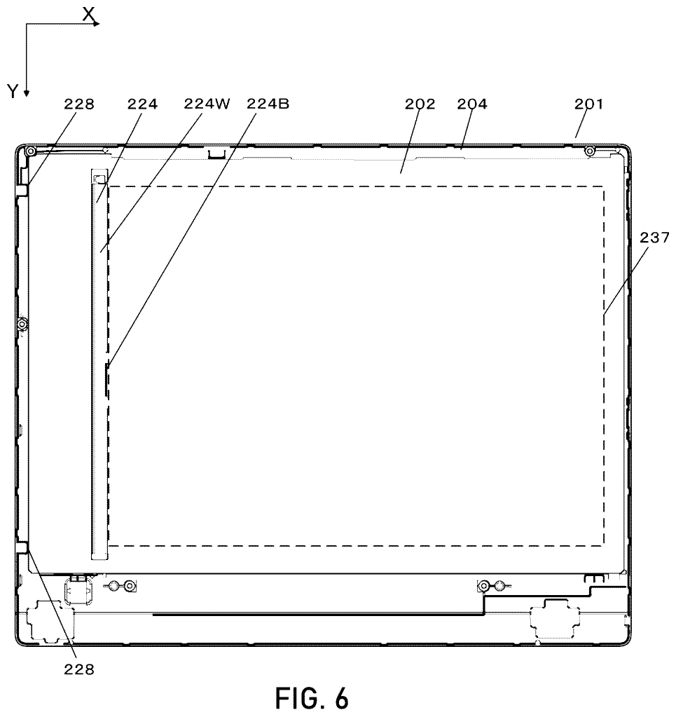

In the diagram, a white sheet 224 is arranged on a side of a sheet mounting surface of the sheet set table glass 202. While a white region 224W and a black region 224B are displayed in the present sectional view for simplicity's sake, an actual configuration is as described later with reference to FIG. 6.

FIG. 6 is a rear view of the glass frame unit 201 shown in FIG. 5A and illustrates a part of the white sheet 224. The sheet set table glass 202 is abutted against two glass frame abutted portions 228 of the glass frame 204 to determine a position of the sheet set table glass 202 in the X direction. The white sheet 224 is arranged on a rear surface side of the sheet set table glass 202 in a direction of view of the present diagram which is a same surface as the sheet mounting surface. In FIG. 6, the X-direction position of the white sheet 224 is arranged between the glass frame abutted portions 228 and a stationary sheet reading area 237. In addition, the white region 224W for performing shading correction of the image sensor 206 and the black region 224B to be a reference position in the sub-scanning direction of the image sensor 206 shown in FIG. 7 are integrally provided in the white sheet 224. The white sheet 224 for performing shading is large enough to cover an entirety of the image sensor 206 shown in FIG. 7 in the main scanning direction. A position of the black region 224B in the sub-scanning direction (X direction) in the white sheet 224 is formed on a side closer to the stationary sheet reading area 237 than the white region 224W.

FIG. 7 shows a diagram of a state where the glass frame unit 201 has been removed from the top view shown in FIG. 5A in order to show an entire internal configuration of the scanner portion 200 and shows an arrangement and a configuration of the reading unit 207 and a base frame 223.

A guide rail 221 of which a longitudinal direction is the sub-scanning direction is arranged at an approximately central portion in the Y direction of the base frame 223. A slider 218 of the reading unit 207 described earlier is arranged so as to be slidable in the sub-scanning direction (X direction) along the guide rail 221. When drive is input to a motor 220, a belt 222 moves in accordance with the input and the reading unit 207 is to reciprocally scan along the guide rail 221 through a drive transmitting portion to which the belt 222 is connected.

While the present embodiment represents a belt drive type reading unit in which a drive portion is arranged on the base frame 223 and a driving force of the drive portion is transmitted by a belt, the present embodiment can also be adopted for a self-propelled reading unit in which the drive portion is arranged in the reading unit 207.

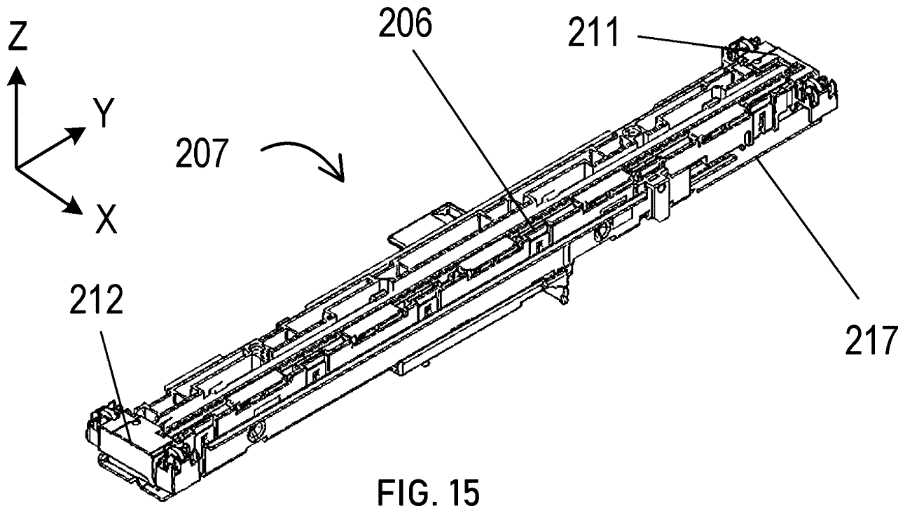

FIG. 15 is a perspective view of the reading unit 207. The reading unit 207 includes the image sensor 206, a sensor holder 217, and the slider 218. The image sensor 206 has a longitudinal direction and a transverse direction and the longitudinal direction is also referred to as the main scanning direction. The reading unit 207 is scanned in the sub-scanning direction (scan direction) which is a direction in an intersecting direction (typically, a perpendicular direction) intersecting the main scanning direction. A roller unit which guarantees a focal length from a document to be read is preferably arranged at both end portions in the main scanning direction of the image sensor 206 and a rotatable roller is preferably arranged at distal ends of the roller units in the sub-scanning direction. In addition, preferably, biasing means such as a pressing spring is arranged between the image sensor 206 and the sensor holder 217 to constantly press the image sensor 206 against a rear surface of a document table glass. Due to such a configuration, the reading unit 207 can smoothly move in the sub-scanning direction due to the rollers while being pressed against the glass of the document table.

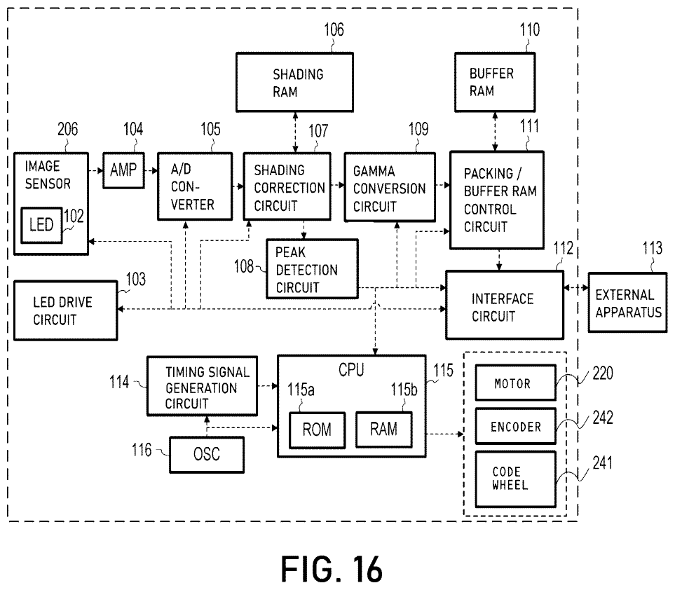

FIG. 16 is a block diagram showing an example of a configuration of a control portion of the entire apparatus. Hereinafter, circuit operations of the present case will be described. The image sensor 206 is a sensor in which LEDs 102 of three colors which are a light source are integrated. In the case of the sheet fixed reading system, the image sensor 206 is moved in the scan direction under the document table glass. At the same time, by switching among the LEDs 102 of the respective colors and lighting the selected LED 102 for each line with an LED drive circuit 103, an RGB line-sequential color image can be read. In the case of the sheet transported reading system, a document is read by the stopped image sensor 206 while transporting the document. An amplifier (AMP) 104 amplifies a signal output from the image sensor 206. An A/D converter 105 performs A/D conversion of an amplified output of the amplifier 104 and obtains, for example, an 8-bit digital output.

A shading RAM 106 stores data for shading correction having been obtained by reading the white region 224W for the shading described above and by subjecting the data to arithmetic processing. A shading correction circuit 107 performs shading correction of image data read by the image sensor 206 based on the data of the shading RAM 106. A peak detection circuit 108 is a circuit which detects a peak value in read image data for each line and which is used in order to detect a reference position of the reading unit 207. A gamma conversion circuit 109 performs gamma conversion of the read image data according to a gamma curve set in advance.

A buffer RAM 110 is a memory for temporarily storing image data in order to synchronize timings between an actual read operation and communication with a host computer. A packing/buffer RAM control circuit 111 performs processing for writing, to the buffer RAM 110, data subsequent to performing packing according to an image output mode set in advance by the host computer and processing for transferring and outputting image data from the buffer RAM 110 to an interface circuit 112. Note that image output modes include binary, 4-bit multi-value, 8-bit multi-value, and 24-bit multi-value. The interface circuit (transferring means) 112 described above receives control signals from an external apparatus 113 and outputs image signals to the external apparatus 113. The external apparatus 113 is an apparatus such as a personal computer to become a host apparatus (computer) of the image reading apparatus.

A CPU 115 is a CPU which includes a ROM 115a storing processing procedures and a working RAM 115b, which controls various portions according to procedures of a program stored in the ROM 115a, and which is configured as, for example, a microcomputer. The CPU 115 controls a rotation direction, a rotational speed, and a rotation amount of the motor 220 by reading, with an encoder 242, slit information of a code wheel 241 coaxially fixed with the motor so as to be rotatable. In other words, the CPU 115 controls a movement direction, a movement speed, a distance, and the like of the reading unit 207. An OSC 116 is an oscillator such as a quartz oscillator. A timing signal generation circuit 114, according to settings of the CPU 115, divides a frequency of an output of the OSC 116 to generate various timing signals to be used as a reference of operations.

In the present embodiment, a boundary between the black region 224B and the white region 224W serves as a reference mark for image reading by the image sensor 206. The reference mark read by the image sensor 206 is detected by the encoder and stored as a reference position in the RAM 115b in the CPU 115. The CPU 115 functions as control means of detection of the reference mark, determination of the reference position of the image sensor 206 according to the detected reference mark, start of reading of an image, and the like. The CPU 115 further moves the image sensor 206 in the sub-scanning direction based on the reference position determined according to a reference mark detected in the sub-scanning direction.

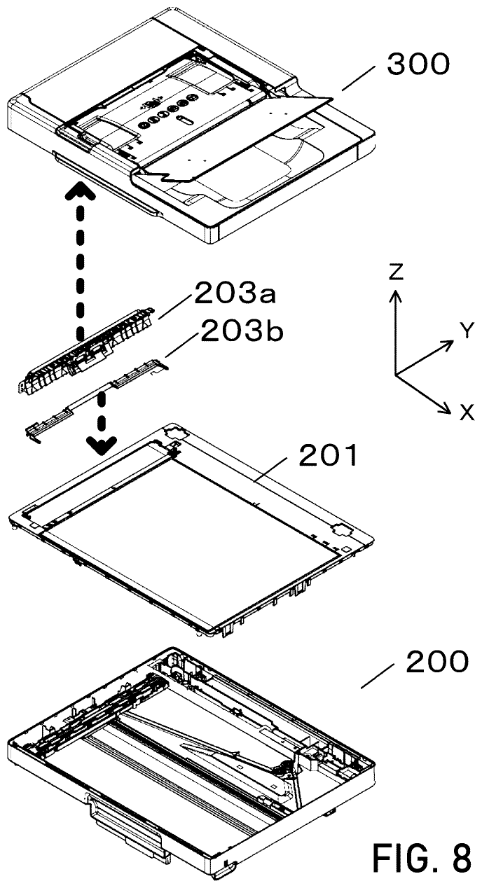

Hereinafter, a configuration of the first transport guide 203a and the second transport guide 203b according to the present embodiment will be described with reference to FIGS. 8 to 12.

FIG. 8 is an exploded view of the scanner portion 200 and the ADF portion 300 according to the present embodiment. The first transport guide 203a is attached to the ADF portion 300 and the second transport guide 203b is fixed to the glass frame unit 201 of the scanner portion 200.

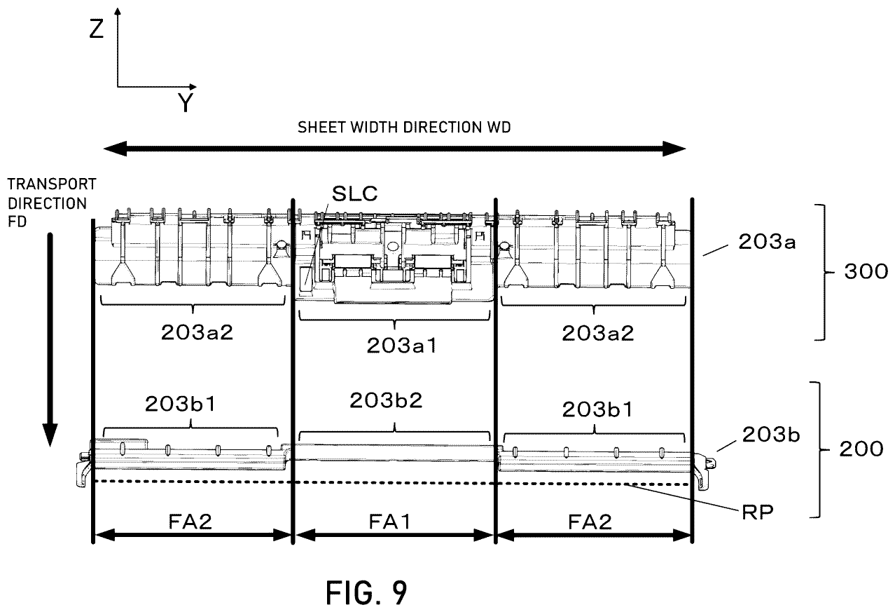

FIG. 9 is an exploded view showing a positional relationship between the first transport guide 203a and the second transport guide 203b during sheet transport according to the present embodiment. As described earlier, conventionally, for example, at end portions of the first transport guide 203a, warpage in the X direction and the Z direction is particularly likely to occur and causes lift of a sheet. In consideration thereof, the present embodiment is provided with the illustrated first transport guide 203a and the second transport guide 203b which will be described below.

The first transport guide 203a and the second transport guide 203b according to the present embodiment include a first transport region FA1 and a second transport region FA2 in a sheet width direction WD. In the sheet width direction WD of the illustrated example, the first transport region FA1 is positioned in a central portion while the second transport region FA2 is positioned in both end portions. In the first transport region FA1, the transported sheet 310 is guided to a transported document reading portion RP by the first transport guide 203a and, in the second transport region FA2, the transported sheet 310 is guided in sequence by the first transport guide 203a and the second transport guide 203b and transported to the transported document reading portion RP. In other words, by having a central portion lifted in an extended portion 203al, the transported sheet 310 directly reaches the transported document reading portion RP without coming into contact with a retracted portion 203b2. The transported document reading portion RP is a position where the fixed image sensor 206 reads an image while the transported sheet 310 is being transported and a position which extends in a direction perpendicular to the transport direction of the sheet.

The first transport guide 203a respectively includes the extended portion 203al in an approximately central portion in the sheet width direction WD and a retracted portion 203a2 in both end portions in the sheet width direction WD. The second transport guide 203b respectively includes the retracted portion 203b2 in an approximately central portion in the sheet width direction WD and an extended portion 203b1 in both end portions in the sheet width direction WD. In addition, the first transport region FA1 includes the extended portion 203al of the first transport guide 203a and the retracted portion 203b2 of the second transport guide 203b. The second transport region FA2 includes the retracted portion 203a2 of the first transport guide 203a and the extended portion 203b1 of the second transport guide 203b. The second transport region FA2 of the second transport guide 203b is provided with a plurality of ribs for supporting sheets. A vertex of a rib of the second transport region FA2 is positioned higher than the glass frame 24. On the other hand, the extended portion 203al of the first transport guide 203a is not provided with ribs.

Note that in this case, “retract” means that the retracted portion 203a2 is distanced from the transported document reading portion RP. In addition, “extend” means that the extended portion 203a1 is extended longer than the retracted portion 203a2 and a distance to the transported document reading portion RP is shorter. In other words, in the transport direction of a sheet, a downstream-side end portion of the extended portion 203al is closer to the transported document reading portion RP than a downstream-side end portion of the retracted portion 203a2.

The first transport guide 203a is configured in the transport direction FD such that an approximately central portion in the sheet width direction WD is long and both end portions in the sheet width direction WD are short and that the notched portion SLC is provided in a long section of the approximately central portion in the sheet width direction WD. During sheet transport, the sheet is pressed against a vicinity of the notched portion SLC by a force exerted by the sensor lever SL. Due to such a configuration, since the sheet can be supported by a long portion of the first transport guide 203a in a vicinity of the notched portion SLC, an attitude of the sheet can be stabilized. In other words, while realizing a configuration that is advantageous with respect to an inclination of the sheet by installing the sensor lever SL in the central portion in the sheet width direction WD, the long portion of the first transport guide 203a is provided in the central portion to enable the sheet to be readily supported.

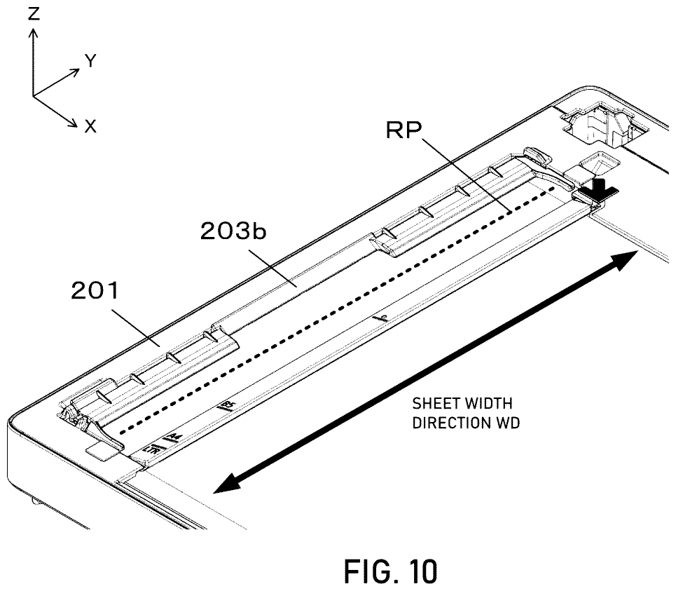

FIG. 10 is a perspective view of a state where the second transport guide 203b according to the present embodiment is fixed to the glass frame unit 201. Both end portions of the second transport guide 203b in the sheet width direction WD are fixed to the glass frame unit to correct deformation due to warpage of the guide. Due to this configuration, lift of both end portions of a sheet in the transported document reading portion RP can be more suppressed as compared to guiding the sheet to the transported document reading portion RP solely by the first transport guide 203a.

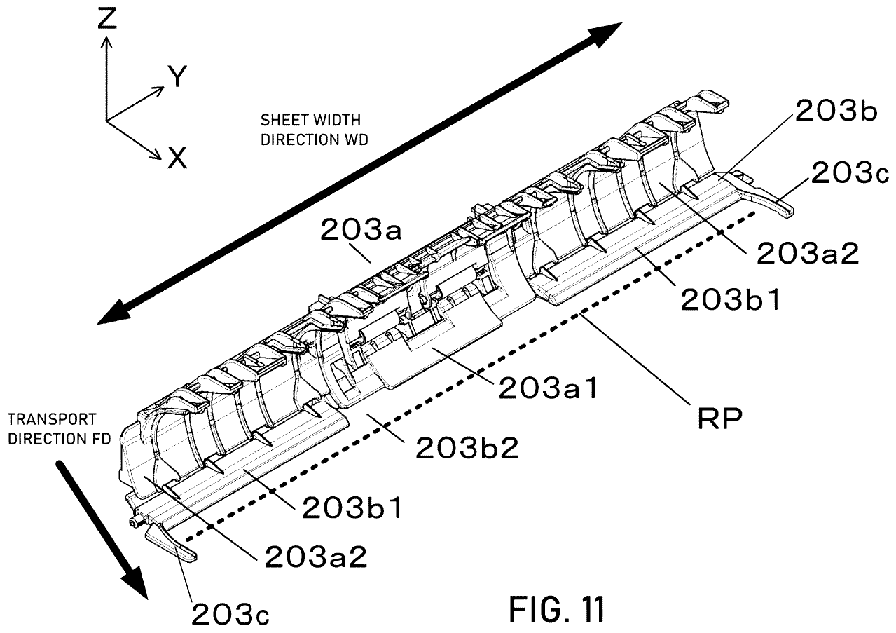

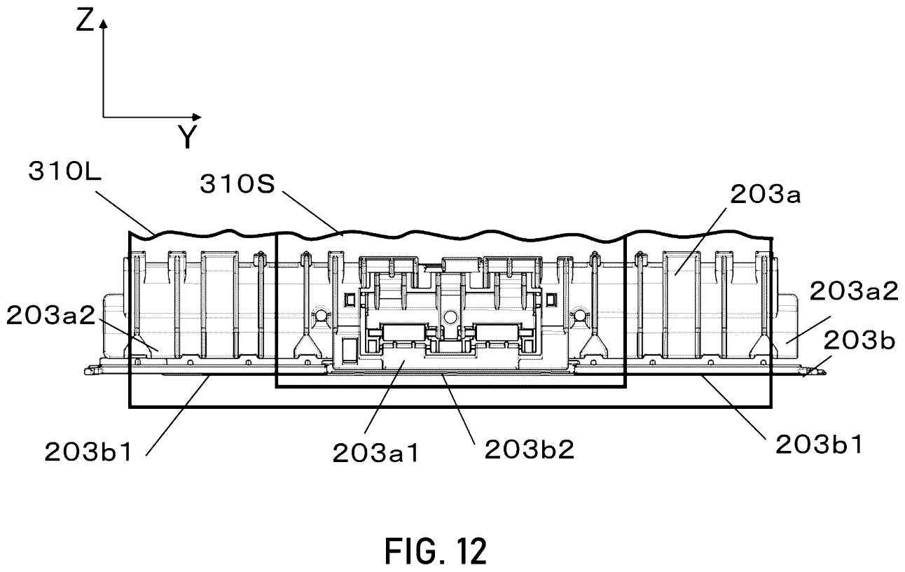

FIGS. 11 and 12 are diagrams showing a positional relationship between the first transport guide 203a and the second transport guide 203b during sheet transport according to the present embodiment.

As shown in FIG. 11, the first transport guide 203a includes the extended portion 203al in an approximately central portion in the sheet width direction WD and the retracted portion 203a2 in both end portions in the sheet width direction WD. The second transport guide 203b includes the retracted portion 203b2 in an approximately central portion in the sheet width direction WD and the extended portion 203b1 in both end portions in the sheet width direction WD. In an approximately central portion in the sheet width direction WD of a transported sheet, after the sheet passes the extended portion 203al of the first transport guide 203a, the sheet is transported to the transported document reading portion RP. On the other hand, in both end portions in the sheet width direction WD of the transported sheet, after the sheet passes the retracted portion 203a2 of the first transport guide 203a, the sheet passes the extended portion 203b1 of the second transport guide 203b and is transported to the transported document reading portion RP. In addition, a fixing portion 203c extends to a downstream side than the transported document reading portion RP from the second transport guide 203b outside a maximum sheet width. The fixing portion 203c prevents the second transport guide 203b from rotating within a plane of the glass frame 204.

Note that “retract” similarly means that the retracted portion 203b2 is distanced from the transported document reading portion RP with respect to the second transport guide 203b. In addition, “extend” means that the extended portion 203b1 is extended longer than the retracted portion 203b2 and a distance to the transported document reading portion RP is shorter. In other words, in the transport direction of a sheet, a downstream-side end portion of the extended portion 203b1 is closer to the transported document reading portion RP than a downstream-side end portion of the retracted portion 203b2.

According to the configuration shown in FIGS. 9 to 12, the first transport guide 203a and the second transport guide 203b overlap with each other in a comb-like manner in the transport direction FD. Therefore, during sheet transport, a sheet can be transported without a leading end of the sheet being caught at a boundary portion between the first transport guide 203a and the second transport guide 203b. Specifically, a sheet end portion can be prevented from being caught by the transport guides by creating a state where the sheet is lifted by the extended portion 203a1.

The first transport guide 203a retracts both end portions in the sheet width direction WD which are susceptible to deformation due to warpage. In addition, the second transport guide 203b fixes both end portions in the sheet width direction WD to the glass frame unit to correct deformation due to warpage. In both end portions in the sheet width direction WD, the sheet is transported to the transported document reading portion RP by being guided by the extended portion 203b1 of the second transport guide 203b of which deformation has been corrected. Due to the configuration shown in FIGS. 9 to 12, lift of the sheet can be suppressed in both end portions in the sheet width direction WD when transporting the sheet to the transported document reading portion RP. While the second transport guide 203b is constituted of a separate component from the glass frame unit in the present embodiment, alternatively, the second transport guide 203b can be integrally constructed with the glass frame unit.

FIG. 12 shows a positional relationship when a corresponding maximum size sheet 310L and a corresponding minimum size sheet 310S are superimposed on the first transport guide 203a and the second transport guide 203b. In an approximately central portion in the sheet width direction WD, both the maximum size sheet 310L and the minimum size sheet 310S pass the extended portion 203al of the first transport guide 203a and are subsequently transported to the transported document reading portion. In addition, in both end portions in the sheet width direction WD, after the sheets pass the retracted portion 203a2 of the first transport guide 203a, the sheets pass the extended portion 203b1 of the second transport guide 203b and are transported to the transported document reading portion. According to this configuration, lift of both end portions in the sheet width direction WD of a sheet due to warpage deformation of a guide can be suppressed as long as a size of the sheet is a supported size.

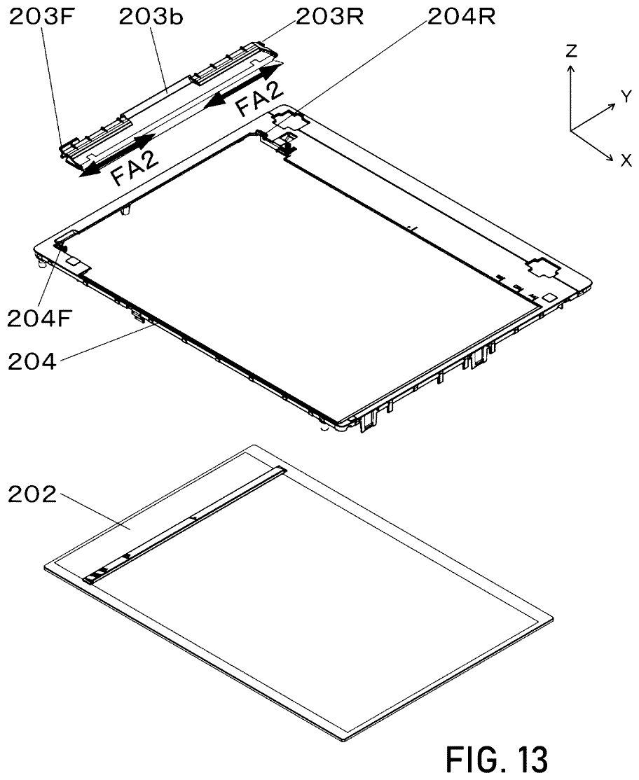

FIG. 13 is an exploded view of the sheet set table glass 202, the second transport guide 203b, and the glass frame 204. The sheet set table glass 202 is attached to the glass frame 204. Subsequently, the second transport guide 203b is attached to the glass frame 204. The second transport guide 203b has engaging shapes 203F and 203R which engage with the glass frame 204 and which are constructed on a side of a second transport region FA2. The engaging shapes 203F and 203R are arranged outside of a transport path in a width direction of a document. The glass frame 204 has engaging portions 204F and 204R. The second transport guide 203b is configured to be attached to the glass frame 204 due to the engaging shape 203F of the second transport guide 203b engaging with the engaging portion 204F of the glass frame 204 and the engaging shape 203R of the second transport guide 203b engaging with the engaging portion 204R of the glass frame 204.

### Second Embodiment

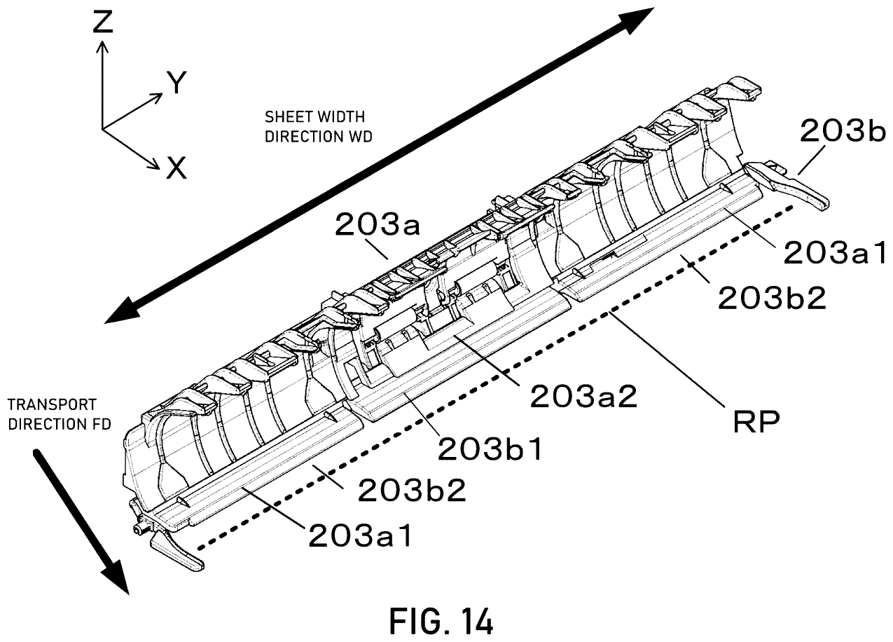

FIG. 14 is a diagram showing a positional relationship between the first transport guide 203a and the second transport guide 203b during sheet transport according to a second embodiment. The first transport guide 203a includes the retracted portion 203a2 in an approximately central portion in the sheet width direction WD and the extended portion 203al in both end portions in the sheet width direction WD. The second transport guide 203b includes the extended portion 203b1 in an approximately central portion in the sheet width direction WD and the retracted portion 203b2 in both end portions in the sheet width direction WD. In an approximately central portion in the sheet width direction WD of a transported sheet, after the sheet passes the retracted portion 203a2 of the first transport guide 203a, the sheet passes the extended portion 203b1 of the second transport guide 203b and is transported to the transported document reading portion RP. In both end portions in the sheet width direction WD of the transported sheet, after the sheet passes the extended portion 203al of the first transport guide 203a, the sheet is transported to the transported document reading portion RP.

According to this configuration, the first transport guide 203a and the second transport guide 203b overlap with each other in a comb-like manner in the transport direction FD. Therefore, during sheet transport, a sheet can be transported without a leading end of the sheet being caught at a boundary portion between the first transport guide 203a and the second transport guide 203b.

The first transport guide 203a retracts the approximately central portion in the sheet width direction WD which is susceptible to deformation due to warpage. In addition, the second transport guide 203b fixes the approximately central portion in the sheet width direction WD to the glass frame unit to correct deformation due to warpage. In the approximately central portion in the sheet width direction WD, the sheet is transported to the transported document reading portion RP by being guided by the extended portion 203b1 of the second transport guide 203b of which deformation has been corrected. Due to the configuration shown in FIGS. 9 to 12, lift of the sheet can be suppressed in the approximately central portion in the sheet width direction WD when transporting the sheet to the transported document reading portion RP. While the second transport guide 203b is constituted of a separate component from the glass frame unit in the present embodiment, alternatively, the second transport guide 203b can be integrally constructed with the glass frame unit.

While embodiments have been described above, it is to be understood that the present invention is not limited to such embodiments and the present invention can be applied to sheet discharge apparatuses other than image recording apparatuses.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-126451, filed on Aug. 2, 2023, which is hereby incorporated by reference wherein in its entirety.

What is claimed is:

1. An image reading apparatus, comprising:
a document transport portion including a transport mechanism configured to transport a document;
a first transport guide which is provided in the document transport portion and which is configured to guide a document transported in a transport direction by the transport mechanism;
a second transport guide which is at least partially arranged on a downstream side of the first transport guide in the transport direction and which is configured to guide a document transported in the transport direction; and
an image reading portion which includes a reading unit provided with the second transport guide and configured to read, at a reading position, an image of a document having passed through a transport path formed by the first transport guide and the second transport guide, wherein
the transport path includes a first transport region and a second transport region that differs from the first transport region in an intersecting direction that intersects with the transport direction, and
a document is guided from the first transport guide to the reading position in the first transport region and guided in an order of the first transport guide, the second transport guide, and the reading position in the second transport region.

2. The image reading apparatus according to claim 1, wherein
the first transport region is located in a central portion in the intersecting direction.

3. The image reading apparatus according to claim 1, wherein
the second transport region is located in a central portion in the intersecting direction.

4. The image reading apparatus according to claim 1, wherein
the first transport guide is configured such that an end portion on a downstream side in the first transport region is closer to the reading position than an end portion on a downstream side in the second transport region.

5. The image reading apparatus according to claim 4, wherein
the second transport guide is configured such that an end portion on a downstream side in the second transport region is closer to the reading position than an end portion on a downstream side in the first transport region.

6. The image reading apparatus according to claim 4, wherein
the first transport guide and the second transport guide constitute the transport path by overlapping with each other in a comb-like manner.

7. The image reading apparatus according to claim 1, wherein
the image reading portion is equipped with a flat plate member having one surface on which the document is arranged during reading and another surface on which the reading unit is arranged, and
the reading unit is configured to read the document via the flat plate member.

8. The image reading apparatus according to claim 1, wherein
the document transport portion is configured to be openable and closeable with respect to the image reading portion, and
the transport mechanism is configured to transport the document and the reading unit is configured to read an image of the document at the reading position when the document transport portion is in a closed state.

9. The image reading apparatus according to claim 1, wherein
the second transport guide is configured to be attachable and detachable with respect to the image reading portion, and
the second transport guide includes, outside the transport path, an engaging shape which engages with the image reading portion in the intersecting direction.

10. The image reading apparatus according to claim 1, wherein
the second transport guide includes a fixing portion which extends toward a downstream side in the transport direction from the reading position.
